(19) United States
(12) Patent Application Publication
(10) Pub. No.: US 2010/0227557 A1
(43) Pub. Date: Sep. 9, 2010

(54) WIRELESS COMMUNICATION SYSTEM AND APPARATUS FOR MANAGING AN UNDERGROUND FACILITY

(75) Inventors: Yun-Jae WON, Yongin-si (KR); Seung-Ok Lim, Seongnam-si (KR); Sun-Hee Kim, Seoul (KR); Jin-Woong Cho, Seoul (KR)

Correspondence Address: North Star Intellectual Property Law, PC, P.O. Box 34688, Washington, DC, 20043, US

(73) Assignee: Korea Electronics Technology Institute, Seongnam-city (KR)

(21) Appl. No.: 12/718,522

(22) Filed: Mar. 5, 2010

(30) Foreign Application Priority Data
Mar. 6, 2009 (KR) 10-2009-0019222

(51) Int. Cl. H04B 7/005

(52) U.S. Cl. 455/41.2

(57) ABSTRACT

A wireless communication system for managing an underground facility includes: at least one sensor node attached to the underground facility configured to transmit a sensing signal via magnetic field communication after detecting the status information of the underground facility in accordance with a driving signal, the driving signal comprising a wake-up signal; and an information collection device configured to: transmit the driving signal to the sensor node; collect the sensing signal transmitted from the sensor node; and transmit the collected information to a monitoring system via short-range wireless communication.

### CROSS-REFERENCE TO RELATED APPLICATION(S)

The present application claims priority to Korean Patent Application No. 2009-0019222, filed Mar. 6, 2009, the entire disclosure of which is hereby incorporated in its entirety for all purposes.

### TECHNICAL FIELD

The following description relates generally to a wireless communication system for managing an underground facility, and more specifically, to a wireless communication system for managing an underground facility capable of providing status information of the underground facilities through accurate measurements in harsh underground environments for a wireless communication.

### BACKGROUND

Magnetic field communication is a wireless communication method which utilizes magnetic field inside of a region which is defined by the distance from the antenna, which is λ/2π, where the electromagnetic field begins to separate from the antenna, and starts to propagate into the free space as an electromagnetic wave. Magnetic field communication works reliably in a harsh environment containing metals, water, soil, or debris of collapsed buildings.

FIG. 1 is a schematic diagram illustrating generation of a magnetic field region which is utilized in a magnetic field communication. When an AC voltage is applied between the feed points of a dipole antenna, an electric field is generated causing an AC current flow in the antenna, and thereby a magnetic field is generated. An electromagnetic field is separated from the antenna at the distance d, which is λ/2π, and transmitted into the free space. At this time, a transmitting unit transmits a data signal via the magnetic field which is modulated using method such as ASK or BPSK, and a receiving unit receives the data signal transmitted via magnetic field from the transmitting unit, and demodulates the data signal using ASK or BPSK method to obtain the original data.

Magnetic field communication enables a reliable wireless communication near water, soil, or metal. Magnetic field communication is highly accepted as an essential wireless communication technology to overcome the limitation of the RFID/USN technologies.

Conventional RFID/USN technologies suffer communication difficulties due to severe interferences in a harsh environment near water, soil, or metal. Table 1 shows a comparison between the magnetic field communication and other short-range wireless communications.

TABLE 1
A comparison of short-range wireless communication technologies

| | | ZigBee | | IEEE | Magnetic field |
|---|---|---|---|---|---|
| Standard | | 802.15.4 | RFID | P1902.1 | communication |
| Application | | Monitor/Control | Tracking | Visibility | Monitor/Control |
| Memory | | 4~32 KB | 0.1 KB | 10 KB | over 10 KB |
| Battery Life (days) | | 10~100 | NA | 3,000 | 3,000~4,000 |
| Bandwidth (Kb/s) | | 20~150 | 1~100 | 1 | 8 |
| Harsh Environment | | X | Δ | ◯ | ◯ |
| (steel/liquid/ | | | (125 KHz) | | |
| underground/etc.) | | | | | |
| Range (m) | | 1~100 | 0.5~5 | 1~10 | 1~15 |
| Anti-collision | PHY | X | X | ◯ | ◯ |
| | MAC | ◯ | ◯ | X | ◯ |
| | | | (not | | |
| | | | effective) | | |

| | | | | |
|---|---|---|---|---|
| Networking | Mesh | X | X | Ad-hoc |

Lifelines such as water supply lines, sewerages, power lines, gas pipes, communication lines, oil pipes, heat pipes are major underground facilities and these are usually buried underground for protection and aesthetic purposes.

However, it is very difficult to determine the state of these underground facilities accurately due to their buried structure. It is very important to check the conditions of those facilities constantly because the impact will be enormous if an accident happens in one of the above mentioned lifelines.

For this reason, methods of collecting status information of the underground facilities on the ground using multiple sensors, attached to the underground facilities, capable of sensing the conditions thereof are being studied. However, the sensing signals detected by the sensors cannot be transmitted to the ground surface using conventional communication methods utilizing RFID/USN technologies.

### SUMMARY

### Technical Problem

Embodiments are provided to solve the problems discussed above, and an objective is to provide a wireless communication system for managing an underground facility which is capable of collecting status information of the underground facility in a harsh environment through a magnetic field communication between the sensor node attached to the facility buried underground and the information collection device located on the ground surface.

Another objective is to provide a wireless communication system for managing an underground facility which can be operated semi-permanently without replacing the battery because the driving power supply of the sensor node can be charged using the magnetic field communication signal transmitted from the information collection device.

Yet another objective is to provide a wireless communication system for managing an underground facility which enables position based monitoring of the underground facility using the distance information between the information collection device and the sensor node, together with the GPS position information of the information collection device.

### Solution to Problem

A wireless communication system for managing an underground facility in accordance with an example embodiment includes: at least one sensor node attached to the underground facility configured to transmit a sensing signal via magnetic field communication after detecting the status information of the underground facility in accordance with a driving signal, the driving signal including: a wake-up signal; and an information collection device configured to: transmit the driving signal to the sensor node; collect the sensing signal transmitted from the sensor node; and transmit the collected information to a monitoring system via short-range wireless communication.

An example of a driving signal in accordance with an embodiment includes a wake-up signal and a charging signal of the sensor node, and each signal has a predetermined period. When the wake-up signal is received, the sensor node wakes up from the idle mode and detects condition of the underground facility and transmits the status data to the information collection device. Soon after the completion of the status data transmission, the sensor node enters again into the idle mode so as to reduce the power consumption. During the idle mode, the battery in the sensor node, which is being used as a driving power supply, is charged through the charging unit using the charging signal which is received during the charging signal period of the driving signal.

An example of a sensor node includes: a sensor configured to transmit the sensing signal by detecting status information of the underground facility in accordance with the wake-up signal; a communication unit configured to perform data communication via magnetic field communication; a charging unit configured to charge a battery by receiving the charging signal which is incorporated in the driving signal transmitted from an information collection device; and a control unit configured to: transmit the sensing signal, detected by the sensor in accordance with the wake-up signal of the driving signal transmitted from the information collection device in accordance with the wake-up period of the driving signal, to the information collection device via magnetic field communication; and transmit a control signal for charging the battery through the charging unit in accordance with the charging period.

An example of an information collection device includes: a magnetic field communication unit configured to: transmit the driving signal to the sensor node via magnetic field communication; and receive the sensing signal transmitted from the sensor node; a short-range communication unit configured to perform data communication with a monitoring system via short-range communication; a memory configured to store the sensing signal of the corresponding sensor node collected by the information collection device; and a controller unit configured to: generate the driving signal in accordance with the sensing schedule of the sensing node; transmit the driving signal to the sensing node from the magnetic field communication unit; collect the sensing signal received from the magnetic field communication unit; and transmit the collected sensing signal to the controller unit through the short-range wireless communication unit.

The information collection device according to an additional feature may calculate the distance between the corresponding sensor node and the information collection device by analyzing the signal strength of the sensing signal for each sensor node, and transmit this information with the sensing signal to the monitoring system.

The information collection device according to another additional feature may further include a GPS receiver unit to calculate and transmit the position information of the corresponding information collection device by receiving the GPS signal transmitted from a GPS satellite by transmitting the present position information, calculated by the GPS receiver unit, together with the sensing signals to the monitoring system, a position-based management of underground facilities can be realized.

### ADVANTAGEOUS EFFECTS

Since magnetic field communication uses low frequencies unlike high frequency RF or UHF RFID, it has very sensitive field attenuation characteristics, and is much less sensitive to the nearby obstacles such as soil and water. Therefore, highly accurate distance measurement can be obtained by using a magnetic field communication.

A wireless communication system for managing an underground facility can readily collect and monitor the status information of the underground facilities in harsh environments by using the magnetic field communication between the sensor nodes attached to the underground facilities and the information collection device located on the ground surface.

A wireless communication system for managing an underground facility can be operated semi-permanently without battery replacement by using the battery in the sensor node as a driving power supply, and charging the battery using the magnetic field communication signal transmitted from the information collection device.

A wireless communication system for managing an underground facility can provide a position based monitoring of the underground facilities by calculating relatively accurate distance between the information collection device and the sensor node through the signal strength analysis of the magnetic field communication, and using the GPS position information.

Other advantageous effects and objectives may be solved that are not described herein, and those described are for example purposes only.

### BRIEF DESCRIPTION OF THE DRAWINGS

FIG. 1 is a schematic diagram illustrating generation of a magnetic field region which is utilized in a magnetic field communication

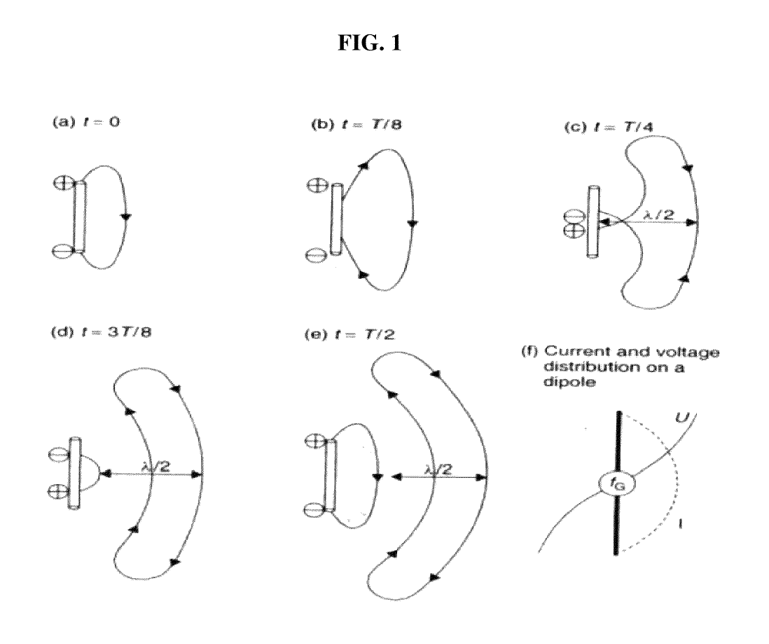

FIG. 2 is a schematic diagram illustrating a wireless communication system for managing an underground facility in accordance with an example embodiment.

FIG. 3 is a block diagram of a sensor node in accordance with an example embodiment.

FIG. 4 is a block diagram of an information collection device in accordance with an example embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

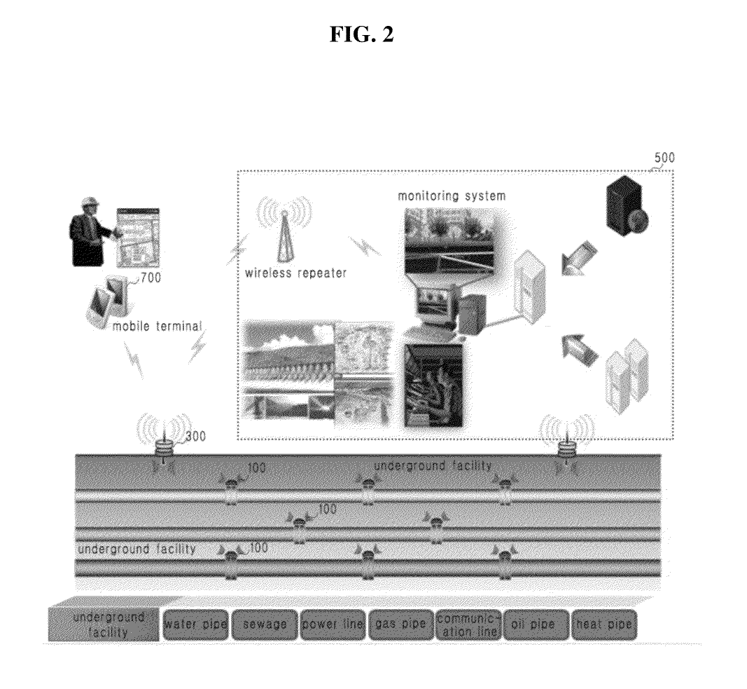

FIG. 2 is a schematic diagram illustrating a wireless communication system for managing an underground facility in accordance with an example embodiment.

A wireless communication system for managing an underground facility in accordance with an example embodiment includes: a plurality of sensor nodes 100 attached to the underground facilities transmitting sensing signals via magnetic field communication after detecting the status information of the underground facilities according to the driving signal which includes a wake-up signal; an information collection device 300 transmitting the driving signals to the sensor nodes 100, collecting the sensing signals transmitted from the sensor nodes 100, and transmitting the collected information via short-range wireless communication; a monitoring system 500 to receive and analyze the sensing signals transmitted from the information collection device 300 and store, manage, and provide the results of the analysis; and a mobile terminal 700, carried by a field manager, to receive the sensing signals transmitted from the information collection device 300, and provide the status information of the underground facilities

A wireless communication system for managing an underground facility may further include a wireless repeater to transmit the collected sensing signals transmitted from the information collection device 300 via short-range wireless communication, to a monitoring system 500 in a remote location.

A monitoring system 500 can be connected to the above mentioned wireless repeater via the internet and may include: a web service server which provides web service using a computer connected via the internet; a database server which stores the status information detected for each underground facility and the result of the analysis; and an analysis server to analyze the sensing signal for each underground facility and store the analysis result to the database server, or provide the analysis result using a display device.

A mobile terminal 700 can be realized by a PDA, a mobile communication terminal, or the like, and may receive and analyze the sensing signals transmitted from the information collection device 300, and may provide present status information of each underground facility in accordance with the analysis result. Such mobile terminal 700 may be carried by the field manager. When the mobile terminal 700 is entered within the service range of the sensing signal of the information collection device 300, the sensing signals transmitted from the information collection device 300 may be received and analyzed to provide the result using a display device thereby the field manager can easily monitor the conditions of the underground facilities.

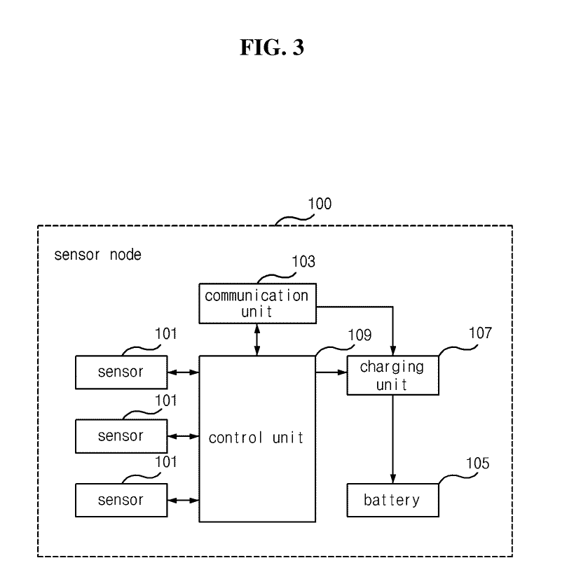

Sensor nodes 100 may be attached and buried underground together with the facilities such as water pipes, sewages, power lines, gas pipes, communication lines, oil pipes, and heat pipes. The sensor nodes 100 may detect the conditions such as temperature, humidity, pressure, and cracks of the corresponding underground facilities and transmit the status information to the information collection device 300 via magnetic field communication. A sensing signal may be transmitted together with identification information to identify corresponding sensor node 100. A sensor node 100 will be described more in detail below in conjunction with FIG. 3.

FIG. 3 is a block diagram of a sensor node in accordance with an example embodiment. As shown in FIG. 3, a sensor node 100 includes: a sensor 101 to generate a sensing signal by detecting the condition of a underground facility responding to a wake-up signal which is included in the driving signal; a communication unit 103 for data communication with the information collection device 300 via magnetic field communication; a charging unit 107 to charge a battery 105 during the charging signal period which is included in the driving signal transmitted from the information collection device 300; and a control unit 109 to transmit the sensing signal, detected by the sensor 101 responding to the wake-up signal in the driving signal transmitted from the information collection device 300 in accordance with the wake-up period of the driving signal, to the information collection device 300 via magnetic field communication, and generate a control signal to charge the battery 105 through the charging unit 107 in accordance with the charging period.

The driving signal which is transmitted to each sensor node 100 by the information collection device 300 may include a wake-up signal and a charging signal, and each of the wake-up signal and the charging signal may have a predetermined period. The charging period of the driving signal may include the period of the driving signal excluding the period of the wake-up signal.

For example, the information collection device 300 may continuously transmit a driving signal to the sensor node 100, but a driving signal carrying a wake-up signal may be transmitted when the time to check the condition of the underground facility arrives. During the time when there is no need to check the condition of the underground facility, the sensor node 100 may operate in a standby mode performing minimum functions to reduce power consumption until it receives a wake-up signal.

Although a sensor 101 which can measure temperature, humidity, pressure, cracks of the underground facility may be sufficient for most purposes, a more sophisticated sensor 101 which can measure various conditions of the underground facility other than the parameters described above may be used. A sensor node 100 may include multiple sensors instead of only one sensor 101.

A communication unit 103 can be realized using a magnetic field communication modem which communicates data with the information collection device 300 via magnetic field communication, and may receive and generate the driving signal transmitted from the information collection device 300, and may transmit the sensing signal detected by the sensor 101 to the information device 300.

A charging unit 107 can be realized by a compact battery charger to charge the battery 105 with the power generated from electrostatic induction of the driving signal received from the communication unit 103 in accordance with the charging period of the driving signal. The driving signal may be an electromagnetic wave transmitted from the information collection device 300, therefore when this electromagnetic wave is received by the antenna of the communication unit 103, then a current may start to flow across the antenna due to the electrostatic induction. The current may be rectified by the charging unit 107 and charges the battery 105.

The power of the battery 105 charged by the charging unit 107 may be used by the sensor 101 for checking the condition of the underground facility responding to the wake-up signal of the driving signal, and for transmitting the sensing signal reflecting the detected condition to the information collection device 300 via magnetic field communication.

A control unit 109 can be realized, for example, by using a microprocessor for an arithmetic operation and a micro-controller whose peripheral circuits are monolithically integrated into a single chip, and may control the operation of each element of the sensor node 100 in response to the wake-up signal transmitted from the information collection device 300.

The control unit 109 may transmit control signal to each part of the sensor node 100 in idle mode forcing them to drive when a driving signal carrying a wake-up signal is received.

In response to a sensing signal reflecting temperature, humidity, pressure, and crack level being transmitted from the sensor 101, the control unit 109 may transmit corresponding sensing signal, carrying its unique identification information, to the communication unit 103, then the communication unit 103 may transmit corresponding sensing signal to the information collection device 300 via magnetic field communication.

Once the transmission of the sensing signal is completed, the control unit 109 may transmit control signal to each part of the sensor node 100 to stop its operation and put them into the idle mode again. At this time, the charging unit 107 may charge the battery 105 with the power generated by electrostatic induction of the charging signal received in accordance with the driving signal which may include the charging signal controlled by the control signal of the control unit 109.

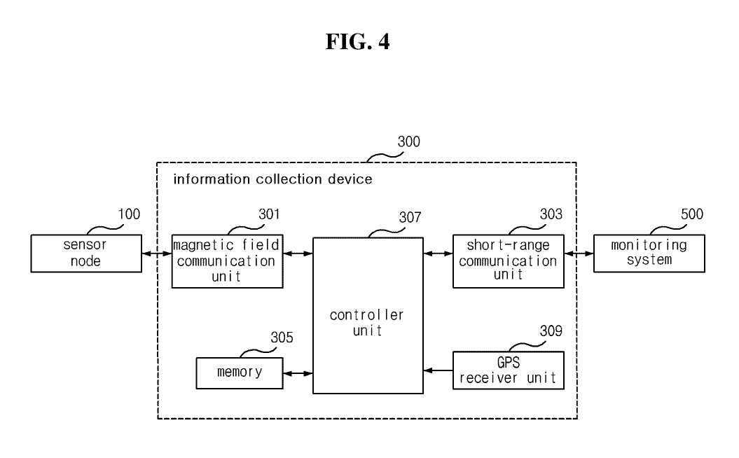

An information collection device 300, installed on the ground surface, may continuously transmit a wake-up signal and a driving signal which carries a charging signal to the multiple sensor nodes 100, and may collect sensing signals transmitted from the individual sensor nodes 100 via magnetic field communication, and may transmit the collected sensing signals via short-range wireless communication. Such an information collection device 300 can be embodied, for example, as a compact transceiver type and/or as a half-buried type structure. This information collection device 300 will be described more in detail below in conjunction with FIG. 4.

FIG. 4 is a block diagram of an information collection device in accordance with an example embodiment. As shown in FIG. 4, the information collection device 300 includes: a magnetic field communication unit 301 which transmits a driving signal to a sensor node 100 via magnetic field communication, and receives a sensing signal transmitted from the sensor node 100; a short-range communication unit 303 which performs data communication with a monitoring system 500 via short-range wireless communication; a memory 305 which stores sensing signal of each sensor node 100 collected by the information collection device 300; and a controller unit 307 which incorporates a wake-up signal into the driving signal in accordance with the sensing schedule of the sensor node 100, and transmits this driving signal to the sensor node 100 through the magnetic field communication unit 301, and collects the sensing signal received from the magnetic field communication unit 301, and transmits this sensing signal to the monitoring system 500 through the short-range communication unit 303.

The magnetic field communication unit 301 may perform data communication with the sensor node 100 via magnetic field communication, and may transmit the driving signal, which may include a wake-up signal and a charging signal in accordance with the control signal of the controller unit 307, to the sensor node 100 which is buried underground, and may transmit the sensing signals received from the multiple sensor nodes 100.

The short-range communication unit 303 may perform data communication with the monitoring system 500 or a mobile terminal 700 using the short-range wireless communication protocols such as, e.g., Bluetooth, Zigbee, and Z-Wave, and may transmit sensing signals of the individual sensor nodes 100 collected by the magnetic field communication unit 301 to the monitoring system 500 or the mobile terminal 700. The short-range communication unit 303 may receive the control signal transmitted from the monitoring system 500 or the mobile terminal 700 and may transmit the control signal to the controller unit 307.

The memory 305 can be realized by, for example, a readable and writable memory such as an EEPROM or a flash memory, and the memory 305 may store sensing signals of the individual sensor nodes 100 received through the magnetic field communication unit 301. Access to these sensing signals of the individual sensor nodes 100 stored in the memory 305 may be controlled by the controller unit 307.

The controller unit 307, like the control unit 109 of the sensor node 100, can be realized by using a microprocessor for an arithmetic operation and a micro-controller whose peripheral circuits are monolithically integrated into a single chip, and may generate and transmit a driving signal carrying a wake-up signal in accordance with a sensing schedule of an underground facility. The controller unit 307 may receive the sensing signal transmitted from the magnetic field communication unit 301 and may store the sensing signal corresponding to each sensor node 100 into the memory 305, and may transmit this sensing signal corresponding to each sensor node 100 to the monitoring system 500 or the mobile terminal 700 through the short-range communication unit 303. If the distance between the information collection device 300 and the monitoring system 500 is too far for an adequate short-range wireless communication, a wireless repeater which is connected to the monitoring system 500 can be further installed.

The information collection device 300 may calculate the distance between the information collection device 300 and the sensor node 100 by detecting the sensing signal, e.g., the magnetic field strength, transmitted from the sensor node 100, and may transmit this calculated distance information together with the collected sensing signal to the monitoring system 500 or the mobile terminal 700.

The controller unit 307 may calculate the distance between the information collection device 300 and the sensor node 100 by measuring the strength of the sensing signal corresponding to each sensor node 100 transmitted from the magnetic field communication unit 301, and may transmit this distance information together with the sensing signal to the monitoring system 500.

As described above, the strength variation with respect to distance for a magnetic field communication may be much larger than the other types of short-range wireless communication, and this fact implies that the distance between the transmitting unit and receiving unit can be measured more accurately in a magnetic field communication system due to its large strength variation with respect to distance. Pre-measured distance data with respect to the underground signal strength of the magnetic field communication may be stored in the memory 305 of the information collection device 300, then the controller unit 307 can calculate the distance between the information collection device 300 and the sensor node 100 by measuring the strength of the sensing signal, e.g., the magnetic field strength, received through the magnetic field communication unit 301, and comparing this with the stored distance data in the memory 305. This calculated distance information may be included in the sensing information and transmitted to the monitoring system 500 or the mobile terminal 700.

The information collection device 300 may further include a GPS receiver unit 309 which calculates and outputs the position of the corresponding information collection device 300 by receiving a GPS signal transmitted from a GPS satellite, and the controller unit 307 may transmit present position information calculated by the GPS receiver unit 309 together with the sensing signal.

The GPS receiver unit 309 may calculate the position information of the information collection device 300 by receiving the GPS signal transmitted from the GPS satellite, and may transmit this calculated position information to the controller unit 307. Since a position calculation method using a GPS signal is widely known nowadays, the detailed description of the method will be omitted. The controller unit 307 may incorporate the position information of the information collection device 300, which may be calculated by the GPS receiver unit 309, into the sensing signal corresponding to each individual sensor node 100, and may transmit this sensing signal via magnetic field communication.

By receiving the position information of the information collection device 300 transmitted through the information collection device 300, the distance information between the information collection device 300 and the sensor node 100, and the status information of the underground facilities, and using the monitoring system 500 or a mobile terminal 700, the conditions of the corresponding underground facilities can be effectively managed, and also a position-based management of the underground facilities becomes possible.

For example, various parameters such as the slope and the degree of bending of a water pipe for each water pipe position can be calculated using the position information of the information collection device 300 and the distance information between the information collection device 300 and the sensor node 100, and when these parameters are transformed into an image, the manager of the monitoring system 500 can visually examine the underground facilities.

A number of example embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wireless communication system for managing an underground facility comprising:
at least one sensor node attached to the underground facility configured to transmit a sensing signal via magnetic field communication after detecting the status information of the underground facility in accordance with a driving signal, the driving signal comprising a wake-up signal; and
an information collection device configured to:
transmit the driving signal to the sensor node;
collect the sensing signal transmitted from the sensor node; and
transmit the collected information to a monitoring system via short-range wireless communication.

2. The wireless communication system for managing an underground facility of claim 1, wherein the driving signal comprises:
a period of the wake-up signal; and
a charging signal for the sensor node.

3. The wireless communication system for managing an underground facility of claim 2, wherein the sensor node further comprises:
a sensor configured to output a sensing signal by detecting the condition of the underground facility responding to the wake-up signal which is included in the driving signal;
a communication unit configured to transmit and receive data with the information collection device via magnetic field communication;
a charging unit configured to charge the battery during the charging signal period which is included in the driving signal transmitted from the information collection device; and
a control unit configured to:
transmit a sensing signal, the signal being detected by the sensor during the wake-up signal period of the driving signal, to the information collection device; and
transmit a control signal to charge the battery through the charging unit during the charging signal period.

4. The wireless communication system for managing an underground facility of claim 3, wherein the information collection device comprises:
a magnetic field communication unit configured to:
transmit the driving signal to the sensor node via magnetic field communication; and
receive the sensing signal which is transmitted from the sensor node;
a short-range communication unit configured for data communication with the monitoring system via short-range wireless communication;
a memory configured to store the sensing signals collected by the information collection device for each sensor node; and
a controller unit configured to:
transmit the driving signal carrying the wake-up signal to the sensor node through the magnetic field communication unit in accordance with the sensing schedule of the sensor node; and
transmit the collected sensing signal, received from the magnetic field communication unit, to the monitoring system through the short-range communication unit.

5. The wireless communication system for managing an underground facility of claim 4, wherein the controller unit is further configured to:
calculate a distance between the information collection device and the sensor node by analyzing the sensing signal corresponding to each sensor node transmitted from the magnetic field communication unit; and
transmit information corresponding to the distance calculation together with the sensing signal to the monitoring system.

6. The wireless communication system for managing an underground facility of claim 5, wherein the controller unit is further configured to utilize the signal transmitted from the sensor node via magnetic field communication in calculation of the distance between the sensor node and the information collection device.

7. The wireless communication system for managing an underground facility of claim 5, wherein the information collection device further comprises a GPS receiver unit configured to calculate and output a position of the corresponding information collection device by receiving a GPS signal transmitted from a GPS satellite.

8. The wireless communication system for managing an underground facility of claim 5, wherein the controller unit is further configured to transmit the position calculated by the GPS receiver unit together with the sensing signal.

9. The wireless communication system for managing an underground facility of claim 8, further comprising a mobile terminal configured to:
receive the sensing signal transmitted from the information collection device via short-range wireless communication; and
display the sensing result.

10. A sensor node, attached to an underground facility, transmitting a sensing signal via magnetic field communication by detecting status information of the underground facility in accordance with a driving signal which carries a wake-up signal and a charging signal, the sensor node comprising:
a sensor configured to transmit the sensing signal by detecting status information of the underground facility in accordance with the wake-up signal;
a communication unit configured to perform data communication via magnetic field communication;
a charging unit configured to charge a battery by receiving the charging signal which is incorporated in the driving signal transmitted from an information collection device; and
a control unit configured to:
transmit the sensing signal, detected by the sensor in accordance with the wake-up signal of the driving signal transmitted from the information collection device in accordance with the wake-up period of the driving signal, to the information collection device via magnetic field communication; and
transmit a control signal for charging the battery through the charging unit in accordance with the charging period.

11. An information collection device transmitting a driving signal which includes a wake-up signal and a charging signal to at least one sensor node which is attached to an underground facility and transmits a sensing signal via magnetic field communication by detecting the condition of the underground facility, collecting the sensing signal transmitted from the sensor node, transmitting the collected sensing signal via short-range wireless communication, the information collection device comprising:
a magnetic field communication unit configured to:
transmit the driving signal to the sensor node via magnetic field communication; and
receive the sensing signal transmitted from the sensor node;
a short-range communication unit configured to perform data communication with a monitoring system via short-range communication;
a memory configured to store the sensing signal of the corresponding sensor node collected by the information collection device; and
a controller unit configured to:
generate the driving signal in accordance with the sensing schedule of the sensing node;
transmit the driving signal to the sensing node from the magnetic field communication unit;
collect the sensing signal received from the magnetic field communication unit; and
transmit the collected sensing signal to the controller unit through the short-range wireless communication unit.

12. The information collection device of claim 11, wherein the controller is further configured to:
calculate information corresponding to a distance between the sensor node and the information collection device by analyzing the sensing signal corresponding each sensor node transmitted from the magnetic field communication unit; and
transmit the distance information together with the sensing signal.

13. The information collection device of claim 12, wherein the controller unit is further configured to utilize the signal transmitted from the sensor node via magnetic field communication in calculation of the distance between the sensor node and the information collection device.

14. The information collection device of claim 12, wherein the information collection device further comprises a GPS receiver unit configured to calculate a present position of the information collection device by receiving a GPS signal transmitted by a GPS satellite.

15. The information collection device of claim 14, wherein the controller unit is further configured to transmit the position calculated by the GPS receiver unit together with the sensing signal.
